(19) United States
(12) Patent Application Publication
(10) Pub. No.: US 2018/0163161 A1
(43) Pub. Date: Jun. 14, 2018

(54) BEVERAGE, ADDITIVE COMPOSITION, AND METHOD RELATING TO THESE

(71) Applicant: SAPPORO HOLDINGS LIMITED, Shibuya-ku (JP)

(72) Inventor: Koji TAKAZUMI, Shibuya-ku (JP)

(73) Assignee: SAPPORO HOLDINGS LIMITED, Shibuya-ku, Tokyo (JP)

(21) Appl. No.: 15/577,836

(22) PCT Filed: Jun. 2, 2016
(86) PCT No.: PCT/JP2016/066400

§ 371 Date: Nov. 29, 2017

(30) Foreign Application Priority Data
Jun. 8, 2015 (JP) 2015-115986

(51) Int. Cl. C12G 3/06; A23L 2/56; A23L 27/20

(52) U.S. Cl. CPC C12G 3/06; A23V 2002/00; A23L 27/2022; A23L 2/56

(57) ABSTRACT

Provided are a beverage having an effectively improved aroma, an additive composition, and methods for those. A beverage according to one embodiment of the present invention includes: 4-methyl-4-sulfanylpentan-2-one (4MSP); and 3-sulfanyl-4-methylpentan-1-ol (3S4MP), in which a content of the 3S4MP is 200 ppt or more and 4,100 ppt or less, and in which a ratio of a content of the 4MSP to the content of the 3S4MP (4MSP/3S4MP value) is 0.2% or more and 2.5% or less.

### TECHNICAL FIELD

The present invention relates to a beverage, an additive composition, and methods for those.

### BACKGROUND ART

In Patent Literature 1, there is a disclosure that a fermented alcoholic beverage having an emphasized hop aroma is produced. In Patent Literature 2, there is a disclosure that a beer-taste beverage, to which a muscat, lychee, mango, and passionfruit-like fruit aroma are imparted, is produced.

### CITATION LIST

### Patent Literature

[Patent Literature 1] JP 2010-252636 A

[Patent Literature 2] JP 2011-244719 A

### SUMMARY OF INVENTION

### Technical Problem

However, hitherto, a variety of trial-and-error attempts have been required in order to impart a desired aroma to a beverage, and it has not been easy to improve the aroma of a beverage.

The present invention has been made in view of the above-mentioned problem, and one of the objects of the present invention is to provide a beverage having an effectively improved aroma, an additive composition, and methods for those.

### Solution to Problem

In order to solve the above-mentioned problem, a beverage according to one embodiment of the present invention includes: 4-methyl-4-sulfanylpentan-2-one (4MSP); and 3-sulfanyl-4-methylpentan-1-ol (3S4MP), in which a content of the 3S4MP is 200 ppt or more and 4,100 ppt or less, and in which a ratio of a content of the 4MSP to the content of the 3S4MP (4MSP/3S4MP value) is 0.2% or more and 2.5% or less. According to the one embodiment of the present invention, a beverage having an effectively improved aroma is provided.

In addition, in the beverage, the content of the 3S4MP may be 400 ppt or more and 3,100 ppt or less, and the 4MSP/3S4MP value may be 0.2% or more and 1.5% or less. In this case, the content of the 3S4MP may be 1,000 ppt or more and 3,100 ppt or less, and the 4MSP/3S4MP value may be 0.4% or more and 1.2% or less. In addition, the beverage may be a beer-taste beverage.

In order to solve the above-mentioned problem, a method of producing a beverage according to one embodiment of the present invention includes producing any one of the foregoing beverages through use of a raw material containing 4-methyl-4-sulfanylpentan-2-one and 3-sulfanyl-4-methylpentan-1-ol. According to the one embodiment of the present invention, a method of producing a beverage having an effectively improved aroma is provided.

In order to solve the above-mentioned problem, a method according to one embodiment of the present invention includes adjusting a content of 3-sulfanyl-4-methylpentan-1-ol (3S4MP) in a beverage to be 200 ppt or more and 4,100 ppt or less, and adjusting a ratio of a content of 4-methyl-4-sulfanylpentan-2-one (4MSP) in the beverage to the content of the 3S4MP to be 0.2% or more and 2.5% or less, to thereby improve an aroma of the beverage. According to the one embodiment of the present invention, a method of effectively improving an aroma of a beverage is provided.

In order to solve the above-mentioned problem, an additive composition according to one embodiment of the present invention includes: 4-methyl-4-sulfanylpentan-2-one; and 3-sulfanyl-4-methylpentan-1-ol, the additive composition being for use in production of any one of the foregoing beverages. According to the one embodiment of the present invention, a method of effectively improving an aroma of a beverage is provided.

### Advantageous Effects of Invention

According to the present invention, a beverage having an effectively improved aroma, an additive composition, and methods for those are provided.

### BRIEF DESCRIPTION OF DRAWINGS

FIG. 1 is an explanatory diagram for showing examples of the results of quantification of aroma components and a sensory test performed for beverages produced in Example 1 according to one embodiment of the present invention.

FIG. 2 is an explanatory diagram for showing examples of the results of quantification of aroma components and a sensory test performed for beverages produced in Example 2 according to one embodiment of the present invention.

FIG. 3 is an explanatory diagram for showing examples of the results of quantification of aroma components and a sensory test performed for beverages produced in Example 3 according to one embodiment of the present invention.

### DESCRIPTION OF EMBODIMENTS

Now, embodiments of the present invention will be described. The present invention is not limited to these embodiments.

The inventor of the present invention has carried out extensive investigations on technical means for improving the aroma of a beverage, and as a result, has found that a specific beverage obtained by blending a plurality of beers produced under different conditions has an aroma unique to the specific beverage, which is not found in related-art commercially available beers.

That is, when the aroma of the specific beverage was compared to the aromas of the related-art commercially available beers, the specific beverage was found to have a “fresh aroma of freshly picked fruit” which is qualitatively different from the aromas of the related-art commercially available beers.

In view of the foregoing, the inventor of the present invention carried out quantitative analysis of components that may contribute to aromas, such as ethyl isobutyrate, ethyl 2-methylbutyrate, ethyl 3-methylbutyrate, isobutyl isobutyrate, ethyl 4-methylpentylate, myrcene, β-methylbutyl isobutyrate, 2-methylbutyl isobutyrate, linalool, Q-citronellol, geraniol, geranyl acetate, 4-methyl-4-sulfanylpentan-2-one (hereinafter referred to as “4MSP”), and 3-sulfanyl-4-methylpentan-1-ol (hereinafter referred to as “3S4MP”), in the specific beverage and commercially available beers, and compared the components to each other.

As a result, it was found that the specific beverage contained specific components, i.e., 4MSP and 3S4MP in specific amounts and a specific amount ratio that were different from those in the related-art commercially available beers. Therefore, it was considered that the specific contents and specific content ratio of 4MSP and 3S4MP contributed to the aroma unique to the specific beverage.

In this connection, hitherto, 4MSP has been known to contribute to a box tree-like aroma, and 3S4MP has been known to contribute to a grapefruit-like aroma. However, the “fresh aroma of freshly picked fruit” has been found to be a hitherto unknown aroma that is qualitatively different from any of the above-mentioned aromas known to be produced by 4MSP and 3S4MP and that is obtained only when the contents and content ratio of 4MSP and 3S4MP are adjusted to respective specific ranges.

A beverage according to one embodiment of the present invention (hereinafter referred to as “beverage of the present invention”) contains 4MSP and 3S4MP, in which the content of the 3S4MP is 200 ppt or more and 4,100 ppt or less, and in which the ratio of the content of the 4MSP to the content of the 3S4MP (hereinafter referred to as “4MSP/3S4MP value”) is 0.2% or more and 2.5% or less. Here, 1 ppt is equivalent to 1×10⁻⁹ g/L. In addition, the content of 4MSP and the content of 3S4MP are measured by a method that will be described later in Examples. The beverage of the present invention has a fresh aroma of freshly picked fruit by virtue of containing 4MSP and 3S4MP in the above-mentioned specific amounts and amount ratio.

In this case, in the beverage of the present invention, the content of 3S4MP may be 250 ppt or more and 4,000 ppt or less, and the 4MSP/3S4MP value may be 0.3% or more and 2.0% or less. In addition, the content of 4MSP in the beverage of the present invention is not particularly limited as long as the content of 4MSP falls within a range defined by the above-mentioned content of 3S4MP and 4MSP/3S4MP value. The content of 4MSP may be, for example, 2.0 ppt or more and 41.0 ppt or less, or 2.5 ppt or more and 40.0 ppt or less.

In the beverage of the present invention, it is preferred that the content of the 3S4MP be 400 ppt or more and 3,100 ppt or less, and the 4MSP/3S4MP value be 0.2% or more and 1.5% or less. In this case, the fresh aroma of freshly picked fruit is more effectively achieved.

In the beverage of the present invention, the content of 3S4MP may be 500 ppt or more and 3,000 ppt or less, and the 4MSP/3S4MP value may be 0.3% or more and 1.0% or less. In addition, the content of 4MSP in the beverage of the present invention is not particularly limited as long as the content of 4MSP falls within a range defined by the above-mentioned content of 3S4MP and 4MSP/3S4MP value. The content of 4MSP may be, for example, 2.5 ppt or more and 31.0 ppt or less, or 3.0 ppt or more and 30.0 ppt or less.

In the beverage of the present invention, it is particularly preferred that the content of the 3S4MP be 1,000 ppt or more and 3,100 ppt or less, and the 4MSP/3S4MP value be 0.4% or more and 1.2% or less. In this case, the fresh aroma of freshly picked fruit is particularly effectively achieved.

In the beverage of the present invention, the content of 3S4MP may be 1,000 ppt or more and 3,000 ppt or less, and the 4MSP/3S4MP value may be 0.5% or more and 1.0% or less. In addition, the content of 4MSP in the beverage of the present invention is not particularly limited as long as the content of 4MSP falls within a range defined by the above-mentioned content of 3S4MP and 4MSP/3S4MP value. The content of 4MSP may be, for example, 4.5 ppt or more and 31.0 ppt or less, or 5.0 ppt or more and 30.0 ppt or less.

The beverage of the present invention may be an alcoholic beverage or a non-alcoholic beverage. The alcoholic beverage is a beverage having an ethanol content of 1 vol % or more (alcohol percentage of 1% or more). The ethanol content of the alcoholic beverage is not particularly limited as long as the ethanol content is 1 vol % or more, and the ethanol content may be, for example, from 1 vol % to 20 vol %. The non-alcoholic beverage is a beverage having an ethanol content of less than 1 vol %. The ethanol content of the non-alcoholic beverage is not particularly limited as long as the ethanol content is less than 1 vol %, and the ethanol content may be, for example, less than 0.5 vol %, less than 0.05 vol %, or less than 0.005 vol %.

The beverage of the present invention may be a sparkling beverage or a non-sparkling beverage. The sparkling beverage is a beverage having foam properties including a foam-forming property and a foam-stability. That is, the sparkling beverage is, for example, a beverage containing a carbon dioxide gas and having: a foam-forming property for forming a foam layer on the top of a liquid surface when poured into a container, such as a glass; and a foam-stability for holding the formed foam for a certain period of time or longer.

The beverage of the present invention may be a sparkling alcoholic beverage or a sparkling non-alcoholic beverage. The non-sparkling beverage is a beverage that does not have the above-mentioned foam properties. The beverage of the present invention may be a non-sparkling alcoholic beverage or a non-sparkling non-alcoholic beverage.

A method of producing a beverage according to one embodiment of the present invention (hereinafter referred to as “production method of the present invention”) is a method including producing the beverage of the present invention described above through use of a raw material containing 4MSP and 3S4MP. The raw material containing 4MSP and 3S4MP is not particularly limited as long as the raw material is a raw material containing 4MSP and 3S4MP and usable in the production of a beverage.

The raw material containing 4MSP and 3S4MP may be, for example, a plant raw material containing 4MSP and 3S4MP and/or an additive composition containing 4MSP and 3S4MP. The additive composition containing 4MSP and 3S4MP to be used as the raw material containing 4MSP and 3S4MP is an additive composition according to one embodiment of the present invention (hereinafter referred to as “composition of the present invention”), which is described later.

The plant raw material containing 4MSP and 3S4MP is not particularly limited as long as the plant raw material is a plant or plant-derived raw material containing 4MSP and 3S4MP and usable in the production of a beverage. The plant raw material containing 4MSP and 3S4MP is preferably, for example, hops containing 4MSP and 3S4MP. That is, the beverage of the present invention is preferably a beverage produced using the hops containing 4MSP and 3S4MP.

In addition, the beverage of the present invention is preferably a beverage containing 4MSP and 3S4MP derived from hops. In this case, the beverage of the present invention may further contain a hop-derived component other than 4MSP and 3S4MP. The hop-derived component other than 4MSP and 3S4MP is, for example, a hop-derived bitterness component (for example, an iso-α-acid) and/or essential oil component (for example, one or more kinds selected from a group consisting of myrcene, humulene, linalool, and geraniol).

As the hops, one or more kinds selected from a group consisting of raw hops, pressed hops, hop powder, hop pellets, hop extract, isomerized hops, low hops, tetrahops, and hexahops may be preferably used. The pressed hops are obtained by compressing dried hop cones. The hop powder is obtained by pulverizing dried hop cones. The hop pellets are obtained by compression-molding the hop powder into pellets. The hop extract is obtained by extracting hops. More specifically, the hop extract is obtained by, for example, extracting hops with ethanol or a carbon dioxide gas.

As the hops containing 4MSP and 3S4MP, only one variety of hops containing 4MSP and 3S4MP may be used, or two or more varieties of hops that are different from each other in contents of 4MSP and 3S4MP (for example, amounts (g) of 4MSP and 3S4MP contained per kg of hop dry weight) may be used. The manner of using two or more varieties of hops is not particularly limited, and includes not only a manner of simultaneously or sequentially adding two or more varieties of hops, but also, for example, a manner of mixing a beverage produced using a first variety and a beverage produced using a second variety.

The production method of the present invention may be a method including producing the beverage of the present invention through use of hops containing 4MSP and 3S4MP, and a plant raw material other than the hops. That is, the beverage of the present invention may be a beverage produced using hops containing 4MSP and 3S4MP, and a plant raw material other than the hops. In this case, the beverage of the present invention contains 4MSP and 3S4MP derived from the hops, and a component derived from the plant raw material other than the hops. The plant raw material other than the hops may contain 4MSP and/or 3S4MP.

The plant raw material other than the hops is not particularly limited as long as the plant raw material other than the hops is a plant or plant-derived raw material usable in the production of a beverage. The plant raw material other than the hops may be, for example, one or more kinds selected from a group consisting of grains (for example, one or more kinds selected from a group consisting of barley, barley-like plant, rice, and corn), beans, and potatoes. Those grains, beans, and potatoes may be germinated or ungerminated.

The production method of the present invention may be a method including producing the beverage of the present invention through use of hops containing 4MSP and 3S4MP, and malt and/or barley and a barley-like plant (ungerminated barley and ungerminated barley-like plant are hereinafter referred to simply as “barley-like plant”). That is, the beverage of the present invention may be a beverage produced using hops containing 4MSP and 3S4MP, and malt and/or a barley-like plant. In addition, in this case, the beverage of the present invention contains 4MSP and 3S4MP derived from the hops, and a malt-derived component and/or a barley-like plant-derived component. The malt is obtained by germinating a barley-like plant.

Herein, the barley-like plant may be, for example, one or more kinds selected from a group consisting of barley, wheat, oat, and rye, and is preferably one or more kinds selected from a group consisting of barley, wheat, and oat, particularly preferably one or more kinds selected from a group consisting of barley and wheat.

The malt may be, for example, one or more kinds selected from a group consisting of barley malt, wheat malt, oat malt, and rye malt, and is preferably one or more kinds selected from a group consisting of barley malt, wheat malt, and oat malt, particularly preferably one or more kinds selected from a group consisting of barley malt and wheat malt.

The production method of the present invention may be a method including producing the beverage of the present invention through use of hops containing 4MSP and 3S4MP without use of malt and a barley-like plant. That is, the beverage of the present invention may be a beverage produced using hops containing 4MSP and 3S4MP without use of malt and a barley-like plant. In addition, in this case, the beverage of the present invention does not contain a malt-derived component and a barley-like plant-derived component and contains 4MSP and 3S4MP derived from the hops.

As described above, the composition of the present invention is a composition that contains 4MSP and 3S4MP and is used for production of the beverage of the present invention described above. That is, the composition of the present invention is a composition that contains 4MSP and 3S4MP and is added in the production method of the present invention described above.

The timing at which the composition of the present invention is added in the production method of the present invention is not particularly limited, and may be anyone or more timings. For example, when alcoholic fermentation is performed in the production method of the present invention, the composition of the present invention is added at one or more timings selected from a group consisting of a time before the alcoholic fermentation, a time during the alcoholic fermentation, and a time after the alcoholic fermentation. In addition, the composition of the present invention is added at one or more timings for each of the time before the alcoholic fermentation, the time during the alcoholic fermentation, and the time after the alcoholic fermentation.

The use of the composition of the present invention is not limited to the use of a single composition containing both 4MSP and 3S4MP, and may be the use of a composition containing 4MSP and a composition containing 3S4MP in combination (combined use thereof).

The form of the composition of the present invention is not particularly limited as long as the composition of the present invention contains 4MSP and 3S4MP and is suitable for being added in the production of a beverage. The form may be a liquid form or a solid form. That is, the composition of the present invention is, for example, a liquid (for example, a solution), a paste, powder, or a tablet.

4MSP and 3S4MP to be contained in the composition of the present invention may be derived from a plant raw material, or may be artificially synthesized. 4MSP and 3S4MP derived from a plant raw material are preferably, for example, derived from hops.

When the composition of the present invention contains 4MSP and 3S4MP derived from hops, the composition of the present invention may further contain a hop-derived component other than the 4MSP and 3S4MP. The hop-derived component other than 4MSP and 3S4MP is, for example, a hop-derived bitterness component (for example, an iso-α-acid) and/or essential oil component (for example, one or more kinds selected from a group consisting of myrcene, humulene, linalool, and geraniol).

In the production method of the present invention, the beverage of the present invention is produced using the raw material containing 4MSP and 3S4MP under such conditions that the contents and content ratio of 4MSP and 3S4MP in the beverage of the present invention to be finally produced fall within the above-mentioned ranges.

That is, for example, two or more raw material liquids produced using the raw material containing 4MSP and 3S4MP under different conditions are mixed at such a ratio that the contents and content ratio of 4MSP and 3S4MP in the beverage to be finally produced fall within the above-mentioned ranges, to thereby produce the beverage of the present invention containing 4MSP and 3S4MP in the amounts and amount ratio within the ranges.

More specifically, in this case, for example, first, the contents of 4MSP and 3S4MP in each of the two or more raw material liquids are measured. Then, a mixing ratio such that the contents and content ratio of 4MSP and 3S4MP in the beverage to be finally produced fall within the above-mentioned ranges is determined on the basis of the results of the measurement. After that, the two or more raw material liquids are mixed at the determined mixing ratio to produce the beverage of the present invention.

The two or more raw material liquids are not particularly limited as long as the beverage of the present invention containing 4MSP and 3S4MP in the amounts and amount ratio within the above-mentioned ranges is produced by mixing the two or more raw material liquids. For example, when hops containing 4MSP and 3S4MP are used as the raw material, the two or more raw material liquids are two or more raw material liquids produced using the hops under different conditions (for example, one or more conditions selected from a group consisting of the variety, use amount, addition timing, and boiling time of hops).

In addition, for example, when the composition of the present invention is used, the two or more raw material liquids are two or more raw material liquids produced by adding the composition of the present invention under different conditions (for example, one or more conditions selected from a group consisting of its addition amount and addition timing).

The raw material liquids are not particularly limited as long as the raw material liquids are produced using the raw material containing 4MSP and 3S4MP described above. The raw material liquids are, for example, raw material liquids produced using the raw material without alcoholic fermentation (for example, raw material liquids each corresponding to wort in the production of a beverage such as beer, or raw material liquids each corresponding to a non-alcoholic beverage produced using the raw material), and/or raw material liquids produced using the raw material through alcoholic fermentation (for example, raw material liquids each corresponding to a fermentation liquid after alcoholic fermentation in the production of beer or the like, and/or raw material liquids each corresponding to a beverage such as beer). In addition, the beverage of the present invention may be produced by performing other steps, such as alcoholic fermentation and the addition of other components, after the mixing of the two or more raw material liquids.

In addition, for example, first, on the basis of the contents of 4MSP and 3S4MP in the raw material (for example, hops and/or the composition of the present invention), a use condition (for example, one or more conditions selected from a group consisting of the addition amount and addition timing (and further, boiling time in the case of hops) of the raw material) such that the contents and content ratio of 4MSP and 3S4MP in the beverage to be finally produced fall within the above-mentioned ranges is determined. After that, the raw material is used under the determined condition to produce the beverage of the present invention.

More specifically, for example, when two or more varieties of hops are used, the contents of 4MSP and 3S4MP in each of the two or more varieties of hops are measured. Then, a use condition (for example, one or more conditions selected from a group consisting of the addition amount, addition timing, and boiling time of each of the varieties) such that the contents and content ratio of 4MSP and 3S4MP in the beverage to be finally produced fall within the above-mentioned ranges is determined on the basis of the results of the measurement. After that, the two or more varieties of hops are used under the determined condition to produce the beverage of the present invention.

In addition, for example, when only one variety of hops is used as the hops, the contents of 4MSP and 3S4MP in the one variety of hops are measured. Then, a use condition (for example, one or more conditions selected from a group consisting of an addition amount, an addition timing, and a boiling time) such that the contents and content ratio of 4MSP and 3S4MP in the beverage to be finally produced fall within the above-mentioned ranges is determined on the basis of the results of the measurement. After that, the one variety of hops is used under the determined condition to produce the beverage of the present invention.

The kind of the beverage of the present invention is not particularly limited as long as the beverage of the present invention contains 4MSP and 3S4MP in the above-mentioned specific amounts and ratio and has a fresh aroma of freshly picked fruit. The beverage of the present invention may be a sparkling beverage or a non-sparkling beverage. The beverage of the present invention may be an alcoholic beverage or a non-alcoholic beverage. The beverage of the present invention may be a sparkling alcoholic beverage or a sparkling non-alcoholic beverage. The beverage of the present invention may be a non-sparkling alcoholic beverage or a non-sparkling non-alcoholic beverage.

The beverage of the present invention may be a beer-taste beverage. The beer-taste beverage is a beverage produced using one or more kinds selected from a group consisting of hops, malt, and a barley-like plant. That is, the beer-taste beverage is a beverage containing one or more kinds selected from a group consisting of a hop-derived component, a malt-derived component, and a barley-like plant-derived component.

Specifically, the beer-taste beverage may be a beverage produced using hops. In this case, the beer-taste beverage contains 4MSP and 3S4MP derived from the hops. In addition, in this case, the beer-taste beverage may further contain the above-mentioned hop-derived component other than 4MSP and 3S4MP.

The beer-taste beverage may be a beverage produced using malt and/or a barley-like plant. In this case, the beer-taste beverage contains a malt-derived component and/or a barley-like plant-derived component. 4MSP and 3S4MP to be contained in the beer-taste beverage in this case are not limited to 4MSP and 3S4MP derived from hops, and may be, for example, artificially synthesized 4MSP and 3S4MP.

The beer-taste beverage may be a beverage produced using hops, and malt and/or a barley-like plant. In this case, the beer-taste beverage contains 4MSP and 3S4MP derived from the hops, and a malt-derived component and/or a barley-like plant-derived component.

The beer-taste beverage may be a beverage produced using hops without use of malt and/or a barley-like plant. In this case, the beer-taste beverage contains 4MSP and 3S4MP derived from the hops and does not contain a malt-derived component and a barley-like plant-derived component.

The beer-taste beverage may be a beverage produced using malt and/or a barley-like plant without use of hops. In this case, the beer-taste beverage contains a malt-derived component and/or a barley-like plant-derived component and does not contain a hop-derived component. 4MSP and 3S4MP to be contained in the beer-taste beverage in this case may be, for example, artificially synthesized 4MSP and 3S4MP.

As described above, in the embodiments of the present invention, the aroma of the beverage is effectively improved by adjusting the contents and content ratio of 4MSP and 3S4MP in the beverage to the specific ranges. Accordingly, the embodiments of the present invention include a method including adjusting the content of 3S4MP in the beverage to be 200 ppt or more and 4,100 ppt or less, and adjusting the 4MSP/3S4MP value in the beverage to be 0.2% or more and 2.5% or less, to thereby improve the aroma of the beverage. In this method, the contents and content ratio of 4MSP and 3S4MP in the beverage are adjusted to the above-mentioned specific ranges through use of conditions that may be adopted in the production method of the present invention as described above.

Next, specific Examples according to the embodiments of the present invention will be described.

### Example 1

As described above, the inventor of the present invention found that a specific beverage obtained by blending a plurality of beers produced under different conditions had a “fresh aroma of freshly picked fruit” unique to the specific beverage, which was not found in related-art commercially available beers.

Then, various aroma-contributing components were quantitatively analyzed for the specific beverage and three kinds of related-art commercially available beers. As a result, the content of 4MSP was below the detection limit value in each of the three kinds of commercially available beers, while being 9 ppt in the specific beverage, and the content of 3S4MP was from 6 ppt to 12 ppt in the three kinds of commercially available beers, while being 701 ppt in the specific beverage. The aromas of the three kinds of commercially available beers were a green-like hop aroma, a floral hop aroma, or a somewhat floral hop aroma.

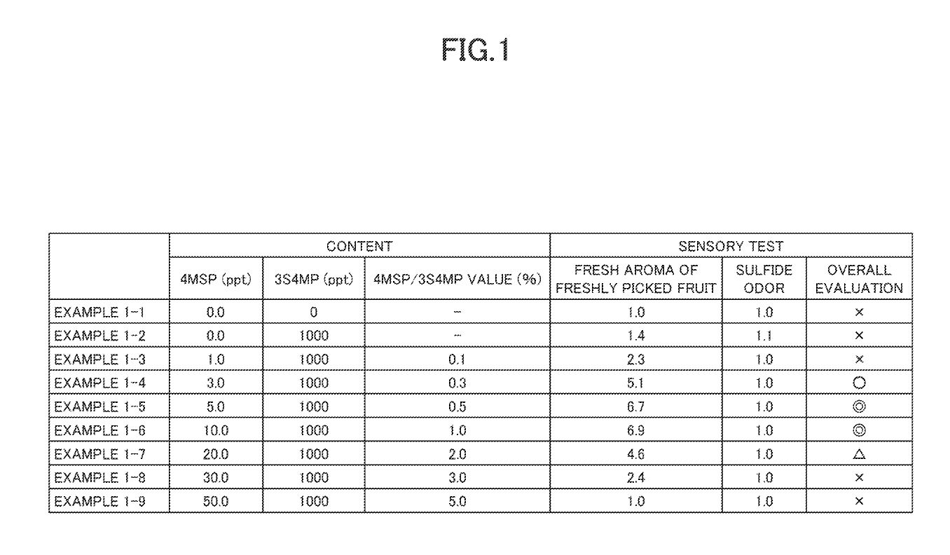

In view of the foregoing, an investigation was carried out on the contents and content ratio of 4MSP and 3S4MP that allowed the achievement of the “fresh aroma of freshly picked fruit” unique to the specific beverage. That is, nine kinds of beverages were produced by adding, to beer produced in advance (sparkling alcoholic beverage produced using barley malt and hops through alcoholic fermentation), a commercially available 4MSP-containing reagent (4-mercapto-4-methylpentan-2-one, manufactured by Combi-Blocks Inc.) (composition containing 4MSP) and a reagent containing artificially synthesized 3S4MP (composition containing 3S4MP) in such amounts that the contents of 4MSP and 3S4MP had any of values shown in Example 1-1 to Example 1-9 of FIG. 1. 3S4MP was synthesized by a method described in paragraph 0048 and paragraph 0049 of JP 2008-214261 A.

The contents of 4MSP and 3S4MP in a beverage are quantified in the following manner. That is, first, 4MSP and 3S4MP contained in the beverage are specifically extracted by reversible binding between 4MSP or 3S4MP and p-hydroxymercuribenzoic acid (p-HMB) in accordance with a method of Tominaga et al. (Tominaga, T et al.: J. Agric. Food Chem. 46, 1044-1048 (1998)). Specifically, to 500 mL of a beverage containing 2.5 nmol of 4-methoxy-2-methylbutane-1-thiol as an internal standard, 100 mL of dichloromethane is added, and extraction is performed in a 1 L flask by stirring with a magnetic stirrer for 10 minutes. The extraction operation is repeated twice.

The organic phases of the two times of extraction are combined, centrifuged at 4,000 g for 15 minutes in order to break an emulsion, and separated with a separatory funnel. To the resultant organic phase, 20 mL of a p-HMB solution (1 mM in 0.2 M Trizma base (2-amino-2-(hydroxymethyl)-1,3-propanediol)) is added twice, followed each time by 10 minutes of extraction. The aqueous phases of the two times of extraction are combined, and applied to a strongly basic anion-exchange column (1.5×3 cm, Dowex1-1×2-100). After that, the column is washed with 50 mL of a sodium acetate buffer (0.1 M, pH 7). 4MSP or 3S4MP is eluted, from a complex of the 4MSP or 3S4MP and p-HMB adsorbed onto the column, by passing 60 mL of a cysteine solution (10 g/L) adjusted to a pH of 7 with 10 M NaOH. An eluate containing 4MSP or 3S4MP is collected in a 100 mL flask, and 0.5 mL of ethyl acetate is added thereto. The eluate is extracted twice with 4 mL and 3 mL of dichloromethane for 10 minutes each time while being stirred with a magnetic stirrer. The organic phases of the two times of extraction are combined, dehydrated with anhydrous sodium sulfate, and concentrated to about 200 μL in a 10 mL graduated test tube under a nitrogen flow. The concentrated liquid is transferred to a 1 mL vial, and further concentrated to 25 μL.

Next, the concentrated sample is analyzed by GC-MS. The GC-MS analysis is performed using 6890N gas chromatography (manufactured by Agilent Technologies) with a mass spectrometer detector (MS5973, manufactured by Agilent Technologies). For each analysis, 3 μL of the concentrated sample is injected into a BP20 capillary column (50 m×0.32 mmp×0.25 μm, manufactured by SGE Analytical Science) with a splitless injector (injection port temperature: 230° C., purge time: 1 minute, purge flow: 50 mL/min) at an oven temperature of 45° C. In all analyses, a temperature program is set as described below. That is, the temperature is held at 45° C. for 10 minutes, then increased at 3° C./min to 230° C., and held at 230° C. for 20 minutes. A carrier gas is a hydrogen gas at a column head pressure of 22 psi, and its flow rate is 1 mL/min. In the Selected Ion Monitoring (SIM) mode, 3S4MP is detected at an m/z value of 134, 4MSP is detected at an m/z value of 132, and the internal standard substance is detected at an m/z value of 134. A calibration curve to be used is created by treating beer containing 3S4MP and 4MSP standard substances at final concentrations of from 0 ppt to 400 ppt in the same manner as with the above-mentioned sample, followed by measurement by a DTNB method (Ellman, G. L.: Arch. Biochem. Biophys. 82, 70-77, 1959). The concentrations of 3S4MP and 4MSP in the sample are quantified by an internal standard method and calculated using the calibration curve.

In addition, each of the nine kinds of beverages obtained as described above was subjected to a sensory test by seven experienced panelists. In the sensory test, each of the panelists gave each of the beverages produced in Example 1-1 to Example 1-9 a score of 1, 2, 3, 4, 5, 6, or 7 for each of a “fresh aroma of freshly picked fruit” and a “sulfide odor”. Then, for each of the beverages, an arithmetic average obtained by dividing the sum of the scores given by the seven panelists by 7 was defined as a score obtained in the sensory test.

For the “fresh aroma of freshly picked fruit”, a higher score is preferred. For the “sulfide odor”, a lower score is preferred. In addition, for each of the beverages, an overall aroma was also evaluated as an “overall evaluation” on the basis of the evaluation results of the “fresh aroma of freshly picked fruit” and the “sulfide odor”.

In FIG. 1, for each of the nine kinds of beverages (Example 1-1 to Example 1-9), as the results of the quantitative analysis, the content (ppt) of 3S4MP, the content (ppt) of 4MSP, and the 4MSP/3S4MP value (%) are shown, and as the results of the sensory test, the score for the “fresh aroma of freshly picked fruit”, the score for the “sulfide odor”, and the result of the “overall evaluation” are shown.

In the column “overall evaluation” of FIG. 1, a “cross mark” denotes that the aroma of a beverage is not preferred, a “triangle mark” denotes that the aroma of a beverage is preferred, a “circle mark” denotes that the aroma of a beverage is very preferred, and a “double circle mark” denotes that the aroma of a beverage is particularly preferred.

As shown in FIG. 1, Example 1-4 to Example 1-7, in each of which the content of 4MSP was from 3.0 ppt to 20.0 ppt, the content of 3S4MP was 1,000 ppt, and the 4MSP/3S4MP value was from 0.3% to 2.0%, were each: given a score of from 4.6 to 6.9 for the “fresh aroma of freshly picked fruit”; given a score of 1.0 for the “sulfide odor”; and evaluated as having a preferred aroma, a very preferred aroma, or a particularly preferred aroma in the “overall evaluation”.

In addition, of those, Example 1-4 to Example 1-6, in each of which the content of 4MSP was from 3.0 ppt to 10.0 ppt and the 4MSP/3S4MP value was from 0.3% to 1.0%, were each: given a score of from 5.1 to 6.9 for the “fresh aroma of freshly picked fruit”, indicating that the “fresh aroma of freshly picked fruit” was extremely effectively achieved; and evaluated as having a very preferred aroma or a particularly preferred aroma in the “overall evaluation”.

Further, Example 1-5 and Example 1-6, in each of which the content of 4MSP was from 5.0 ppt to 10.0 ppt and the 4MSP/3S4MP value was from 0.5% to 1.0%, were each: given a score of more than 6.0, specifically a score of from 6.7 to 6.9 for the “fresh aroma of freshly picked fruit”, indicating that the “fresh aroma of freshly picked fruit” was extremely effectively achieved; and evaluated as having a particularly preferred aroma in the “overall evaluation”.

### Example 2

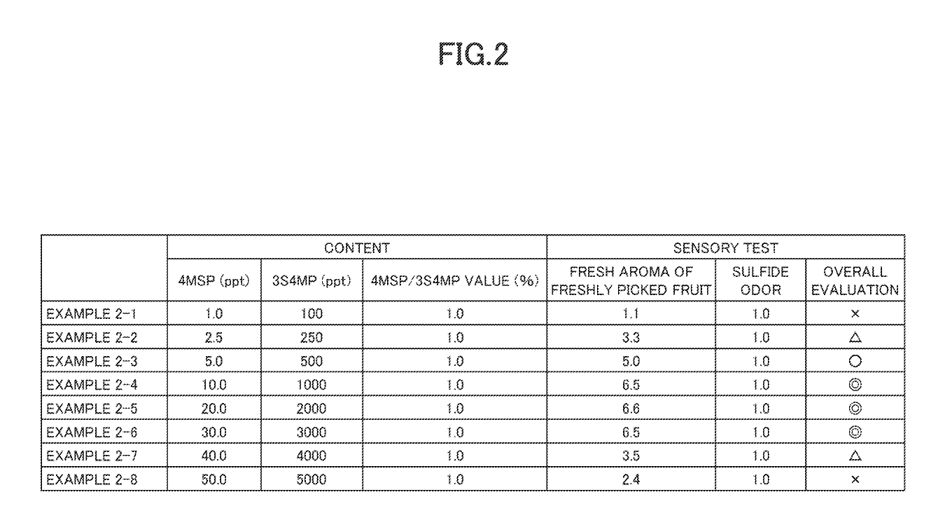

In the same manner as in Example 1 described above, eight kinds of beverages were produced by adding, to beer produced in advance, the 4MSP-containing reagent and the 3S4MP-containing reagent in such amounts that the contents of 4MSP and 3S4MP had any of values shown in Example 2-1 to Example 2-8 of FIG. 2. Then, each of the eight kinds of beverages obtained as described above was subjected to the sensory test by seven experienced panelists in the same manner as in Example 1 described above.

In FIG. 2, for each of the eight kinds of beverages (Example 2-1 to Example 2-8), as the results of the quantitative analysis, the content (ppt) of 3S4MP, the content (ppt) of 4MSP, and the 4MSP/3S4MP value (%) are shown, and as the results of the sensory test, the score for the “fresh aroma of freshly picked fruit”, the score for the “sulfide odor”, and the result of the “overall evaluation” are shown.

As shown in FIG. 2, Example 2-2 to Example 2-7, in each of which the content of 4MSP was from 2.5 ppt to 40.0 ppt, the content of 3S4MP was from 250 ppt to 4,000 ppt, and the 4MSP/3S4MP value was 1.0%, were each: given a score of from 3.3 to 6.6 for the “fresh aroma of freshly picked fruit”; given a score of 1.0 for the “sulfide odor”; and evaluated as having a preferred aroma, a very preferred aroma, or a particularly preferred aroma in the “overall evaluation”.

In addition, of those, Example 2-3 to Example 2-6, in each of which the content of 4MSP was from 5.0 ppt to 30.0 ppt and the content of 3S4MP was from 500 ppt to 3,000 ppt, were each: given a score of from 5.0 to 6.6 for the “fresh aroma of freshly picked fruit”; and evaluated as having a very preferred aroma or a particularly preferred aroma in the “overall evaluation”.

Further, Example 2-4 to Example 2-6, in each of which the content of 4MSP was from 10.0 ppt to 30.0 ppt and the content of 3S4MP was from 1,000 ppt to 3,000 ppt, were each: given a score of more than 6.0, specifically a score of from 6.5 to 6.6 for the “fresh aroma of freshly picked fruit”, indicating that the “fresh aroma of freshly picked fruit” was extremely effectively achieved; and evaluated as having a particularly preferred aroma in the “overall evaluation”.

### Example 3

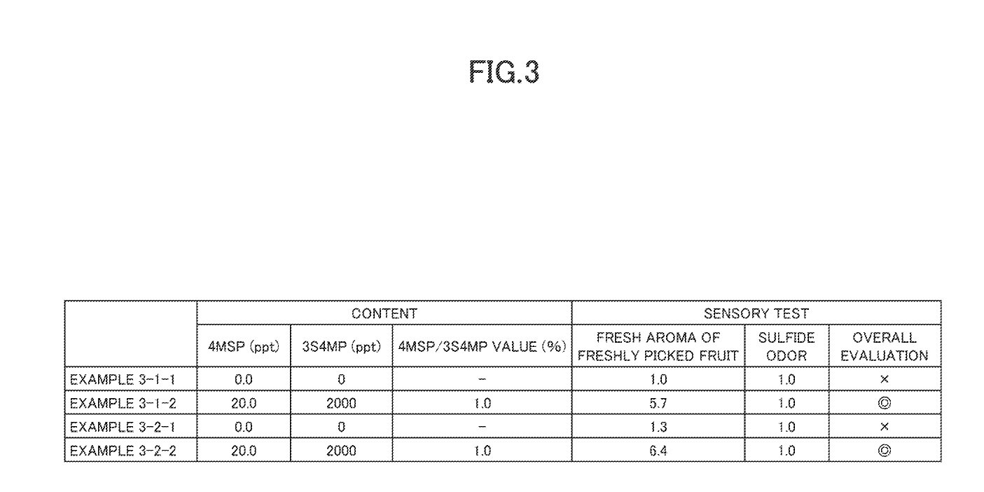

A beverage was produced by adding, to a non-alcoholic beverage produced in advance (sparkling non-alcoholic beverage having a beer taste produced using barley malt and hops without alcoholic fermentation), the 4MSP-containing reagent and the 3S4MP-containing reagent in such amounts that the contents of 4MSP and 3S4MP had values shown in Example 3-1-2 of FIG. 3 in the same manner as in Example 1 described above. For comparison, the above-mentioned non-alcoholic beverage having added thereto none of the 4MSP-containing reagent and the 3S4MP-containing reagent was used as Example 3-1-1.

In addition, a beverage was produced by adding, to an alcoholic beverage produced in advance (sparkling alcoholic beverage having a beer taste produced using beans and hops with alcoholic fermentation without using malt and a barley-like plant), the 4MSP-containing reagent and the 3S4MP-containing reagent in such amounts that the contents of 4MSP and 3S4MP had values shown in Example 3-2-2 of FIG. 3 in the same manner as in Example 1 described above. For comparison, the above-mentioned alcoholic beverage having added thereto none of the 4MSP-containing reagent and the 3S4MP-containing reagent was used as Example 3-2-1. Then, each of the four kinds of beverages obtained as described above was subjected to the sensory test by seven experienced panelists in the same manner as in Example 1 described above.

In FIG. 3, for each of the four kinds of beverages (Example 3-1-1 to Example 3-2-2), the content (ppt) of 3S4MP, the content (ppt) of 4MSP, and the 4MSP/3S4MP value (%) are shown, and as the results of the sensory test, the score for the “fresh aroma of freshly picked fruit”, the score for the “sulfide odor”, and the result of the “overall evaluation” are shown.

As shown in FIG. 3, Example 3-1-2 and Example 3-2-2, in each of which the content of 4MSP was 20 ppt, the content of 3S4MP was 2,000 ppt, and the 4MSP/3S4MP value was 1.0%, were each: given a score of from 5.7 to 6.4 for the “fresh aroma of freshly picked fruit”; given a score of from 1.0 to 1.6 for the “sulfide odor”; and evaluated as having a particularly preferred aroma in the “overall evaluation”.

In particular, Example 3-2-2 was given a score of more than 6.0, specifically 6.4 for the “fresh aroma of freshly picked fruit”, indicating that the “fresh aroma of freshly picked fruit” was extremely effectively achieved.

1: A beverage, comprising:
4-methyl-4-sulfanylpentan-2-one (4MSP); and
3-sulfanyl-4-methylpentan-1-ol (3S4MP),
wherein a content of the 3S4MP is 200 ppt or more and 4,100 ppt or less, and
wherein a ratio of a content of the 4MSP to the content of the 3S4MP (4MSP/3S4MP value) is 0.2% or more and 2.5% or less.

2: The beverage according to claim 1,
wherein the content of the 3S4MP is 400 ppt or more and 3,100 ppt or less, and
wherein the 4MSP/3S4MP value is 0.2% or more and 1.5% or less.

3: The beverage according to claim 2,
wherein the content of the 3S4MP is 1,000 ppt or more and 3,100 ppt or less, and
wherein the 4MSP/3S4MP value is 0.4% or more and 1.2% or less.

4: The beverage according to claim 1, wherein the beverage is a beer-taste beverage.

5: A method of producing the beverage of claim 1, the method comprising:
producing the beverage with a raw material comprising 4-methyl-4-sulfanylpentan-2-one and 3-sulfanyl-4-methylpentan-1-ol.

6: A method, comprising:
adjusting a content of 3-sulfanyl-4-methylpentan-1-ol (3S4MP) in a beverage to be 200 ppt or more and 4,100 ppt or less, and
adjusting a ratio of a content of 4-methyl-4-sulfanylpentan-2-one (4MSP) in the beverage to the content of the 3S4MP to be 0.2% or more and 2.5% or less, to thereby improve an aroma of the beverage,
wherein the beverage comprises the 4MSP and the 3S4MP.

7: An additive composition, comprising:
4-methyl-4-sulfanylpentan-2-one; and
3-sulfanyl-4-methylpentan-1-ol,
wherein the additive composition is suitable for producing the beverage of claim 1.
